(19) United States
(12) Patent Application Publication
(10) Pub. No.: US 2011/0136030 A1
(43) Pub. Date: Jun. 9, 2011

(54) HIGH TEMPERATURE PEM FUEL CELL WITH THERMAL MANAGEMENT SYSTEM

(75) Inventors: Gaelle Laura Garozzo VALENCIA, Boca Raton, FL (US); Thomas J. Pavlik, Palm Beach Gardens, FL (US); Marcela Torres, Boca Raton, FL (US); Santiago Bresani, Boca Raton, FL (US); Luis Riera, Boca Raton, FL (US); James Braun, Lake Worth, FL (US)

(73) Assignee: EnerFuel, Inc., West Palm Beach, FL (US)

(21) Appl. No.: 12/960,089

(22) Filed: Dec. 3, 2010

Related U.S. Application Data
(60) Provisional application No. 61/266,480, filed on Dec. 3, 2009.

(51) Int. Cl. H01M 8/04; H01M 8/24

(52) U.S. Cl. 429/435; 429/457; 429/535

(57) ABSTRACT

A high temperature proton exchange medium (PEM) fuel stack system includes features for enhancing the thermal management of the fuel cell. The fuel cell can include a plurality of membrane-electrode-assemblies (MEA) separated by bipolar plates. The upper and lower edges of the bipolar plates are configured such that a plurality of fins is formed therein. Air can be passed along the fins in the upper edges of the plates and along the fins in the lower edges in opposite directions. A plurality of channels is formed on one or both surfaces of the bipolar plates. The channels extend along a serpentine path. Except for the end plates, hydrogen is supplied to the channels on one side of each plate and air is supplied to the channels on the channels on the opposite side of each plate. Such features keep the fuel cell within acceptable temperature limits during operation.

### CROSS-REFERENCE TO RELATED APPLICATIONS

This application claims the benefit of Provisional Application Ser. No. 61/266,480 entitled “HIGH TEMPERATURE PEM FUEL CELL WITH THERMAL MANAGEMENT SYSTEM”, filed Dec. 3, 2009, which is herein incorporated by reference in its entirety

### FIELD OF THE INVENTION

The invention relates in general to fuel cells and, more particularly, to high temperature proton exchange medium fuel cells.

### BACKGROUND OF THE INVENTION

A fuel cell electrochemically combines hydrogen and oxygen to produce electricity. Byproducts of the energy-generating electrochemical reaction in a fuel cell include water vapor and carbon dioxide. The electrochemical reaction also generates heat. In a stack plate fuel cell where numerous plates are stacked together and sandwich multiple electrochemical layers, heat dissipation from internal portions of the stack remains a challenge. Current heat management techniques rely on thermal cooling layers disposed adjacent to each electrochemical layer and between each set of plates. For a fuel cell having a stack of numerous plates and electrochemical layers, conventional heat removal techniques for each layer would significantly increase the fuel cell package thickness, volume, and size, thereby rendering the fuel cell impractical or infeasible for many applications. Historically, some of the most difficult operations in high temperature fuel cells are temperature control and temperature spread across the membrane-electrode-assembly (MEA) of the fuel cell. Thus, there is a need for a system that can effectively manage heat within a fuel cell.

### SUMMARY

Aspects of the invention are directed to a high temperature proton exchange medium (PEM) fuel stack system with enhanced thermal management features. The fuel cell can include a plurality of membrane-electrode-assemblies (MEA) separated by bipolar plates. The bipolar plates can comprise a plurality of repeating units and two non-repeating units, one on each end of the stack of repeating units. The upper and lower edges of the repeating units and non-repeating units are configured such that a plurality of fins is formed therein. A coolant, such as air, can be passed along the fins in the upper edges of the units in a first direction. A coolant, such as air, can be passed along the fins in the lower edges of the units in a second direction that is opposite the first direction.

Alternatively or in addition, a plurality of channels can be formed on both major surfaces of the repeating units and on one surface of each of the non-repeating units. The channels can extend along a serpentine path. Fuel, such as hydrogen, can be supplied to the channels on one side of each repeat unit, and on one side of one of the non-repeat units. Oxidant, such as air, can be supplied to the channels on the channels on the opposite side of each repeat unit and on one side of the other one of the non-repeat units.

Such features can keep the temperature of the fuel cell within acceptable limits.

### BRIEF DESCRIPTION OF THE DRAWINGS

FIG. 1 is an exploded view of one cell of PEM fuel cell stack configured in accordance with aspects of the invention.

FIG. 2 is a perspective view of a non-repeat unit of a fuel cell stack configured in accordance with aspects of the invention.

FIG. 3 shows portions of a fuel cell assembly configured in accordance with aspects of the invention.

FIG. 4 shows one possible coolant flow system in accordance with aspects of the invention.

FIG. 5A shows a computational flow dynamics thermal analysis of a repeat unit configured in accordance with aspects of the invention.

FIG. 5B is a chart showing the temperature profile across the MEA from corner to corner of a repeat unit configured in accordance with aspects of the invention.

FIG. 6 shows a computational flow dynamics thermal analysis of the pressure drop across the edge protrusions of a bipolar plate configured in accordance with aspects of the invention.

FIG. 7 shows a perspective view of a high temperature fuel cell assembly in accordance with aspects of the invention, showing heaters and knife blowers mounted on the fuel cell assembly.

### DETAILED DESCRIPTION

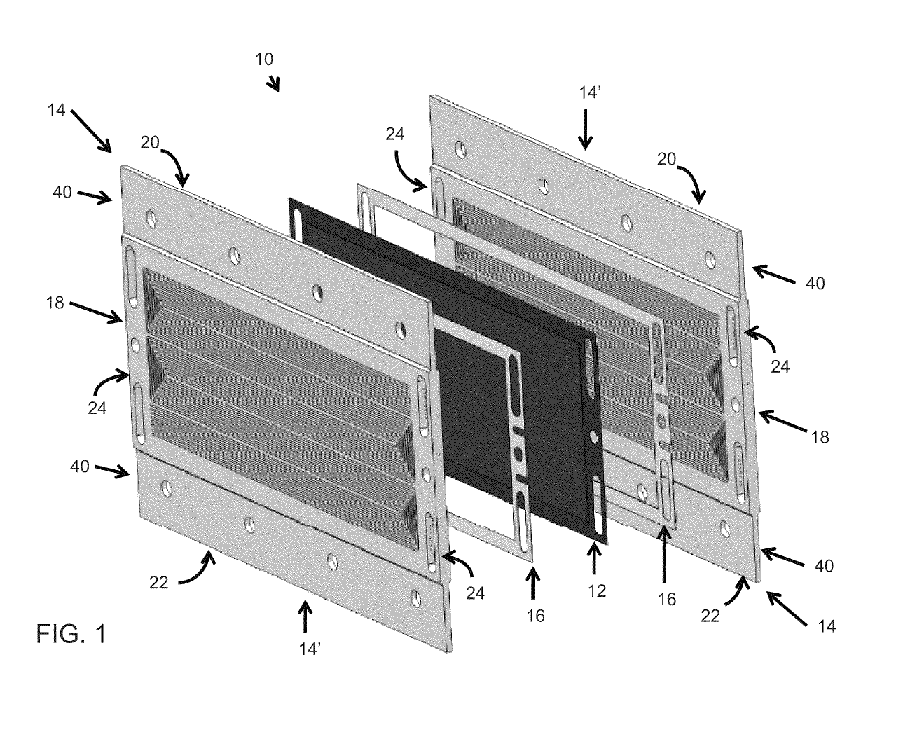

Embodiments of the invention are directed to a thermal management system for a high temperature PEM fuel cell. The term “high temperature PEM fuel cell” means a fuel cell that operates at a temperature of at least about 120° C. In some instances, a high temperature fuel cell can operate in a temperature range of about 120° C. to about 200° C. Various possible aspects of the invention will be explained herein, but the detailed description is intended only as exemplary. Embodiments of the invention are shown in FIGS. 1-7, but the invention is not limited to the illustrated structure or application.

Referring to FIG. 1, a one cell bipolar proton exchange medium (PEM) fuel cell stack 10 is shown. The fuel cell 10 can include a membrane-electrode-assembly (MEA) 12 between two bipolar plates 14, which can be, for example, an electrically conductive graphite bipolar plate. In one embodiment, the bipolar plates 14 can be made of graphite TG-728. The bipolar plates 14 can have very high thermal conductivity in the x-y plane and good thermal conductivity in the through or z plane. Between the MEA 12 and each of the bipolar plates 14, there can be a non-conductive gasket 16, which can provide a seal for distributing the fuel (i.e., hydrogen) and the oxidant (i.e., air) to the MEA 12. The bipolar plates 14 can be repeat units 14′; that is, a plurality of substantially identical bipolar plates that is used in the PEM fuel stack 10. In operation, there are flow fields on both sides of a repeat unit 14′—one side for the fuel and the other one for the oxidant. Each repeat unit 14′ can have a central portion 18, an upper end 20 and an opposite lower end 22. Further, each repeat unit 14′ can have opposing lateral ends 24.

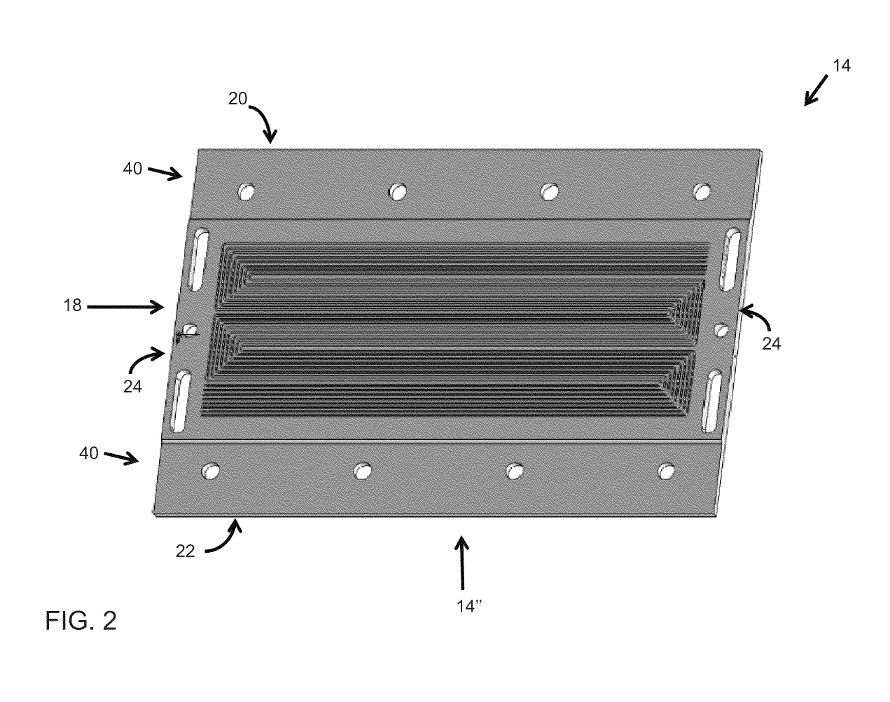

A fuel cell assembly 10 can also include two non-repeat units 14″. A “non-repeat unit” is a bipolar plate with a flow field on only one side of the bipolar plate 14. An example of a non-repeat 14″ unit is shown in FIG. 2. The non-repeat units 14″ are the first and last plates in the stack of plates forming the fuel cell. As a result, one of the non-repeat units 14″ has a fuel flow field on one side of the plate 14, and the other non-repeat unit 14″ has an oxidant flow field on one side of the plate 14. Each non-repeat unit 14″ can have a central portion 18, an upper end 20, and an opposite lower end 22. Further, each non-repeat unit 14″ can have opposing lateral ends 24.

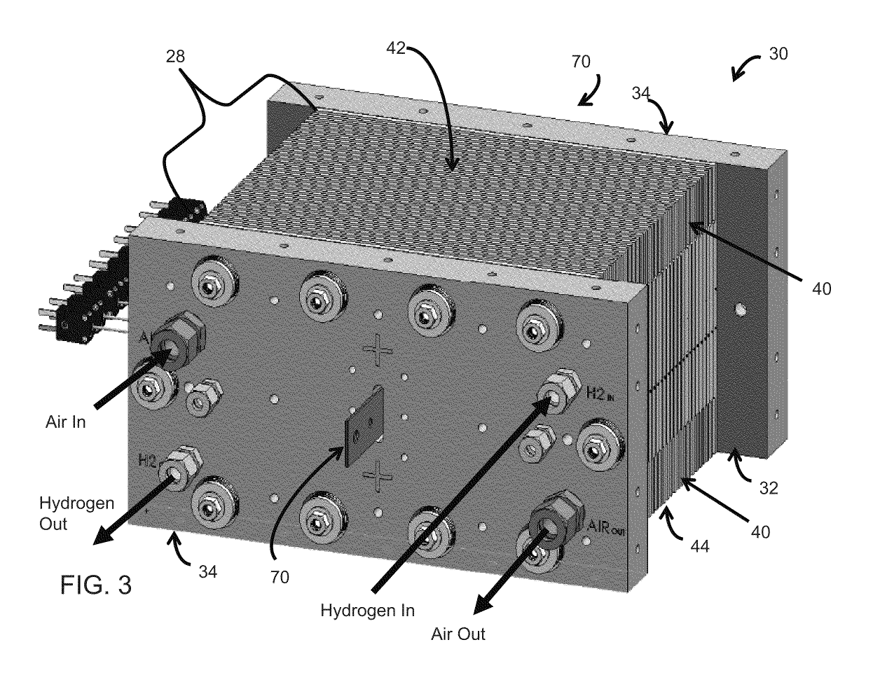

When the components are assembled, a plurality of cells 28 is formed, as shown in FIG. 3. One example of such a fuel cell assembly 30 is shown in FIG. 3. Generally, there can be X cells in the assembly, X−1 repeat units and 2 non-repeat units. In one embodiment, there can be a 32 cells assembly with 31 repeat units and 2 non-repeat units. However, aspects of the invention are not limited to such a construction and can readily be used in connection with greater or fewer cells in the assembly. The plurality of cells 28 can be sandwiched between two current collector plates 32, coupled to positive and negative electrical terminals 70, and two thick insulating end-plates 34, such as shown in FIG. 3.

The upper and lower edges 20, 22 of the bipolar plates 14, both for repeating units 14′ and non-repeating units 14″, can be configured so that a portion of the material of the plate 14 is removed, thereby leaving a protrusion or fin 40. That is, The fin 40 can be thin relative to the thickness of the rest of the plate 14, i.e., thinner than central portion 18. In one embodiment, material can be removed from the front and back side of the plate 14 in the edge region such that the fin 40 is centrally located along the respective edge of the plate. However, in other embodiments, the fin 40 can be closer to or at one of the sides of the plate 14. In one embodiment, the non-repeat units 14″ can have material removed on only one face of the plate, as shown in FIG. 2, and the repeat units 14′ can have material removed from both sides of each plate, as shown in FIG. 1. The fins 40 can have any suitable size, shape. In one embodiment, the fins 40 can be about 0.10 inches thick and about 1.25 inches tall. The fins 40 can extend along at least a portion of the respective edge of the bipolar plate 14.

When the plurality of plates 14 is stacked together in the fuel cell assembly 30, a plurality of fins is formed along the top 42 and bottom 44 of the fuel cell assembly 30. There can be any suitable spacing between the fins 40. In one embodiment, the fins 40 can be spaced about 0.20 inches apart. The spacing between each neighboring pair of fins 40 can be the same or the spacing can be different between at least one pair of fins 40 of neighboring plates. Any suitable coolant, such as air, can be supplied by at least one coolant source 60 to the space between the fins 40 and flow laterally along the fins 40. Any suitable structure for coupling the coolant source(s) 60 to the fuel cell assembly 30 can be used in the various embodiments of the invention. For example, a coolant source can be a blower, a gas cylinder, or any other source of gas in fluid connection with the fins 40 in fuel cell assembly.

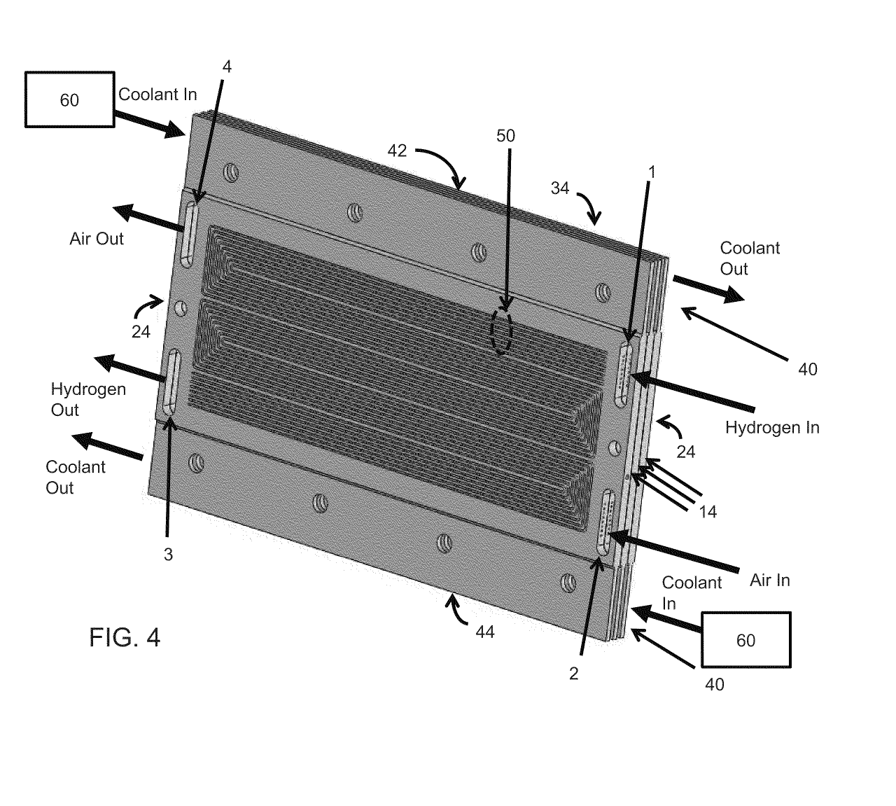

FIG. 4 shows the one example of fluid flow into the fuel cell in which a counter flow cooling scheme can be employed. For instance, as shown in FIG. 4, coolant flow in the fins 40 in the top 42 of the fuel cell 30 can flow in a first direction, and coolant flow in the fins 40 in the bottom 44 of the fuel cell assembly 30 can flow in a second direction that is opposite the first direction. In the scheme illustrated in FIG. 4, the flow of coolant can be provided by one or more coolant sources 60, as shown in FIG. 4. However, in some embodiments, a single coolant source can be provided for cooling fins 40 in the top 42 and bottom 44 of fuel cell assembly 30.

On one side of each repeat unit 14′ and on one side of only one of the non-repeat units 14″, hydrogen can enter into an individual cell by way of slot 1. The slot 1 can have any suitable configuration. The flow can then split into a plurality of channels 50. In one embodiment, there can be eight channels. In one embodiment, the channels can have a depth of about 0.040 inches. The channels can be generally parallel to each other over their entire path. The channels can have any suitable size, shape and configuration. The channels 50 can be formed by recesses in the plate 14 or by raised structures formed on the face of the plate 14. The channels 50 can be substantially identical to each other or at least one of the channels 50 can be different from the other channels 50 in one or more respects. The channels 50 can extend across each bipolar plate 14 in a direction from one lateral end 24 to the opposite lateral end 24. The channels 50 can be generally serpentine. In one embodiment, the channels 50 can turn on itself five times before exiting through the slot 3, as is shown in FIG. 4.

On the other side of each repeat unit 14′ and on one side of the second of the non-repeat units 14″, air can enters into an individual cell by way of slot 2. The air can be transported from the slot 2 to the surface of the bipolar plate 14 using angled channels (not shown). The flow can then split into a plurality of channels (not shown). There can be any suitable quantity of channels. In one embodiment, there can be eight channels. In one embodiment, the channels can have a depth of about 0.040 inches.

The channels can be generally parallel to each other over their entire path. The channels can have any suitable configuration. The channels can be substantially identical to each other or at least one of the channels can be different from the other channels in one or more respects. The channels can extend across each bipolar plate 14 from one lateral end 24 to the opposite lateral end 24. The channels can be generally serpentine. In one embodiment, the channels can turn on itself five times before exiting through the slot, as is shown in FIG. 4. As a result, the flow in one laterally extending segment of the channels can be flowing in an opposite direction of the airflow in a neighboring one of the laterally extending segments of the channels.

The channels for the hydrogen can be substantially identical to the channels for the air. As they are situated on the opposite side of a repeating plate, the direction of flow of the hydrogen can be opposite to the direction of flow of air. In some instances, the channels for the hydrogen can be different from the channels for the air in one or more respects.

This combination of fins, slots and serpentine channels can reduce the risk of a MEA impingement.

Because of the exothermic reaction that occurs in the MEA, a maximum of 55 W of heat can be generated per cell. In some cases, the MEA manufacturer recommends operating the fuel cell at a temperature of 140° C. to 180° C.; however, the temperature spread across the MEA should be as low as possible. To maintain a small temperature spread, the cells can be cooled by supplying air to the space between fins and passing air along the fins. Air can be introduced into the fins using a counter flow strategy, as shown in FIG. 4. The best advantage in high temperature fuel cell systems is the amount of component used. Low temperature fuel cell systems requires humidifiers, compressors, heat exchanger and recycle streams to be efficient; whereas high temperature fuel cells only need heaters before starting up the fuel cell.

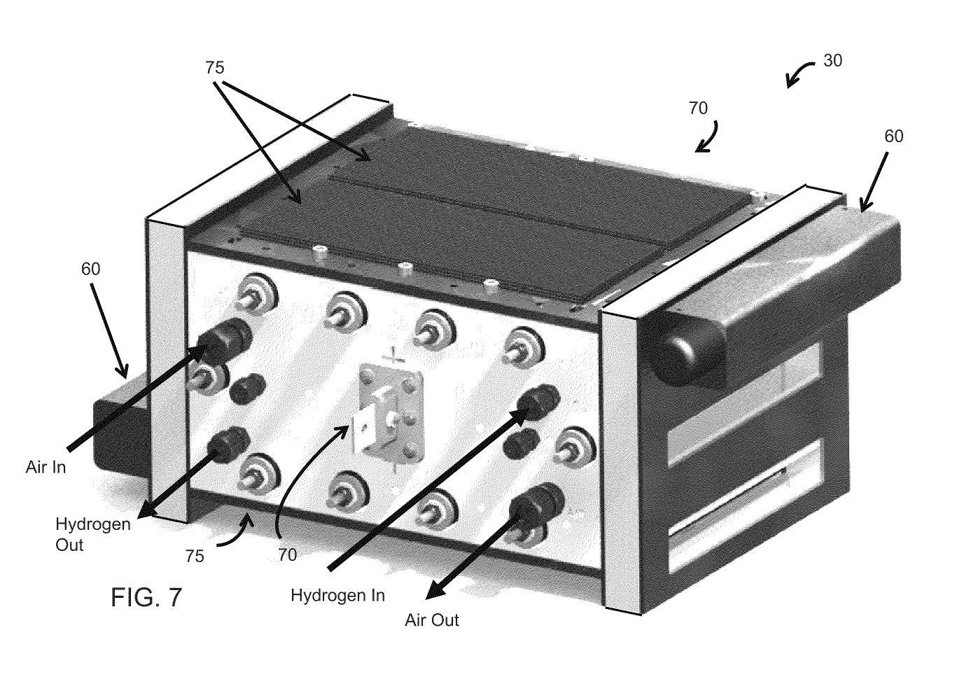

Before operating the high temperature fuel cell assembly 30, heaters 75 can be used to heat-up the stack to 140° C., as is shown in FIG. 7. Any suitable type of heater can be used. In one embodiment, the heaters 75 can be surface mounted heaters.

To minimize temperature spread, the coolant flow must be even across each fuel cell. Accordingly, two coolant sources 60, such as knife blowers, can be used to create substantially even flow and can be positioned on both side of the stack to provide a counter flow strategy. The knife blowers can be used to direct air or any other type of coolant gas into the fuel cell assembly 30. This counter flow strategy will minimize the temperature spread across the MEA.

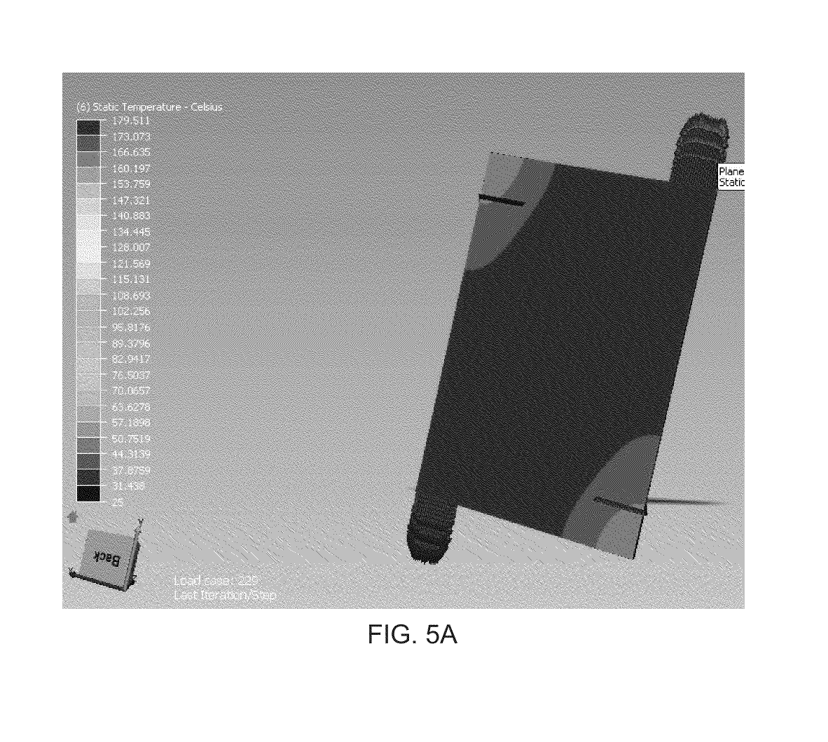

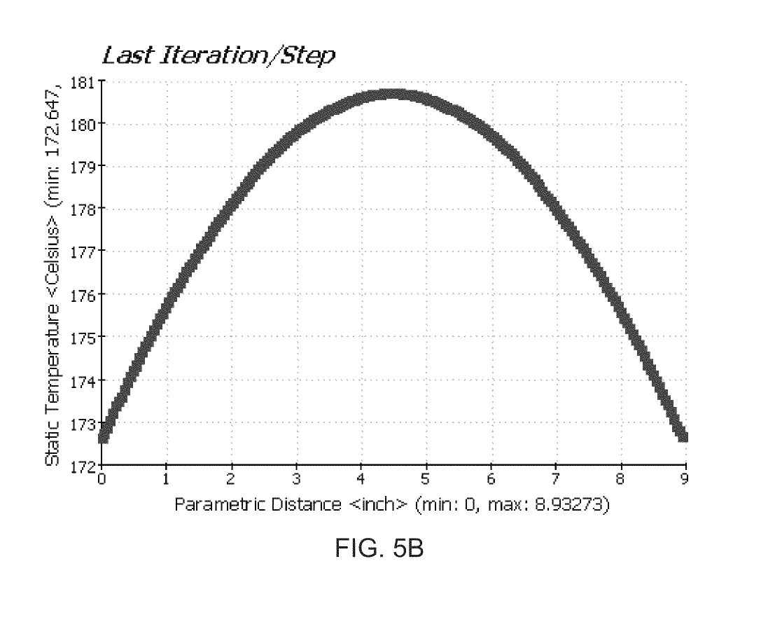

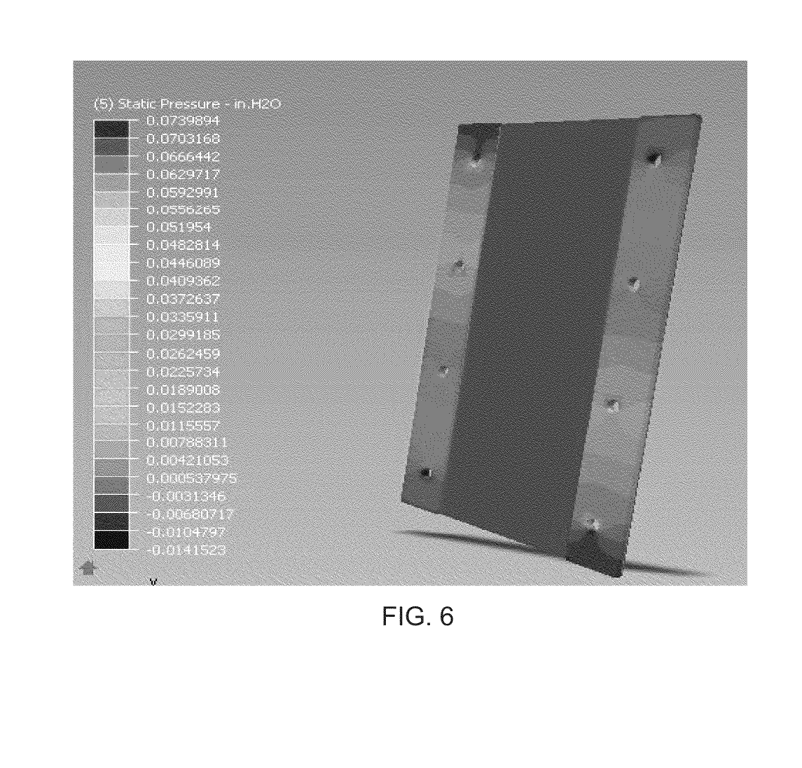

FIG. 5 shows the computational flow dynamics (CFD) thermal analysis of one cell for a heat generation of 55 W per cell and an air coolant temperature of 25° C. Various analyses on the fin thickness were made because the air knife blowers only can sustain a pressure drop of 0.3 in H₂O. FIG. 6 depicts the CFD analysis of the pressure drop across the fins. Flowing a total of 18 L/min of air per cell or 9 L/min on each wing resulted in a temperature difference of 8° C. and a maximum temperature of 180.7° C. across the MEA. The analysis also resulted in a pressure drop of 0.074 in H₂O across the wings, as shown in FIG. 6. Analysis on extreme temperature conditions (−40° C. and 50° C.) was also performed. It was proven that by increasing or decreasing the inlet coolant air temperature, the temperature conditions and the pressure drop across the wings could be managed. Finally, insulating foam can be mounted to the stack to remain as efficient as possible and prevent any heat loss to the environment.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Thus, it will be understood that the invention is not limited to the specific details described herein, which are given by way of example only, and that various modifications and alterations are possible within the scope of the invention.

What is claimed is:

1. A fuel cell system, comprising:
a stack comprising a plurality of membrane-electrode-assemblies (MEAs) and one or more bipolar plates separating the plurality of MEAs, wherein the bipolar plates comprise a plurality of repeating units and two non-repeating units, wherein the non-repeating units are positioned at each end of the stack, and wherein the upper and lower edges of the plurality of repeating units and the two non-repeating units are configured to form a plurality of fins when the stack is formed.

2. The fuel cell of claim 1, further comprising at least one fluid connection for coupling at least one coolant source with the plurality of fins to supply the plurality of fins with the coolant, wherein the fluid connection is configured to allow the coolant to be passed along the fins in the upper edges of the units in a first direction and to allow the coolant to be passed along the fins in the lower edges of the units in a second direction that is opposite the first direction.

3. The fuel cell of claim 1, wherein each of the plurality of repeating units and each of the non-repeating units comprises a first plurality of channels formed along a first major surface, and wherein each of the plurality of repeating units further comprises a second plurality of channels formed along a second major surface.

4. The fuel cell of claim 3, wherein at least one of first and the second plurality of channels is at least partially embedded along a respective one of the first and second major surfaces.

5. The fuel cell of claim 3, wherein at least one of the first and the second plurality of channels extend along a serpentine path.

6. The fuel cell of claim 5, wherein the serpentine path is configured to have a plurality of direction changes.

7. The fuel cell of claim 3, wherein each of the plurality of repeating units and each of the non-repeating units further comprises first, second, third, and fourth slots configured to be in substantial alignment when the stack is formed, wherein the first and third slots are in fluid communication with the first plurality of channels, and wherein the second and fourth slots are in fluid communication with the second plurality of channels.

8. A method of assembling a fuel cell system, comprising:
forming a stack comprising a plurality of membrane-electrode-assemblies (MEAs) and one or more bipolar plates separating the plurality of MEAs, wherein said forming comprises:
selecting the bipolar plates to comprise a plurality of repeating units and two non-repeating units,
positioning the non-repeating units at each end of the stack, and
arranging the upper and lower edges of the plurality of repeating units and the two non-repeating units to form a plurality of fins.

9. The method of claim 8, further comprising:
arranging at least one coolant source in fluid connection with the plurality of fins to supply the plurality of fins with the coolant, wherein the fluid connection is configured to allow the coolant to be passed along the fins in the upper edges of the units in a first direction and to allow the coolant to be passed along the fins in the lower edges of the units in a second direction that is opposite the first direction.

10. The method of claim 8, wherein the step of selecting further comprises configuring each of the plurality of repeating units and each of the non-repeating units to comprise a first plurality of channels formed along a first major surface and configuring each of the plurality of repeating units to further comprise a second plurality of channels formed along a second major surface.

11. The method of claim 10, wherein the step of selecting further comprises configuring at least one of first and the second plurality of channels to be at least partially embedded along a respective one of the first and second major surfaces.

12. The method of claim 10, wherein the step of selecting further comprises configuring at least one of the first and the second plurality of channels extend along a serpentine path.

13. The method of claim 12, wherein the serpentine path is configured to have a plurality of direction changes.

14. The method of claim 10, wherein the step of selecting further comprises configuring each of the plurality of repeating units and each of the non-repeating units to further comprise first, second, third, and fourth slots configured to be in substantial alignment when the stack is formed, wherein the first and third slots are configured to be in fluid communication with the first plurality of channels, and wherein the second and fourth slots are configured to be in fluid communication with the second plurality of channels.

15. A bipolar plate for a fuel cell stack, comprising an electrically conductive plate with first and second opposing major surfaces, the electrically conductive plate further comprising:
a central portion;
opposing top edge and bottom edge portions defining fins, wherein a thickness of the fins is less that than a thickness of the central portion;
a first plurality of channels disposed along the first major surface; and
first, second, third, and fourth slots extending through the electrically conductive plate, wherein the first and third slots are in fluid communication with the first plurality of channels.

16. The bipolar plate of claim 15, wherein the electrically conductive plate further comprises a second plurality of channels disposed along the second major surface, wherein the second and fourth slots are in fluid communication with the second plurality of channels.

17. The bipolar plate of claim 15, wherein the first plurality of channels are configured in a serpentine path.

18. The bipolar plate of claim 15, wherein the first plurality of channels are at least partially embedded in the first major surface.

19. The bipolar plate of claim 15, wherein the first and second slots are positioned near a first end of the central portion, and wherein the third and fourth slots are positioned near a second end of the central portion.

20. The bipolar plate of claim 15, wherein the fins recessed with respect to at least one of the first and second major surfaces of the central portion.
